(19) United States
(12) Patent Application Publication
(10) Pub. No.: US 2015/0312847 A1
(43) Pub. Date: Oct. 29, 2015

(54) method of roaming in the event of deficiency of the data service of a mobile telephone network

(71) Applicant: BOUYGUES TELECOM, Paris (FR)

(72) Inventor: FABRICE LEHOUX, Massy (FR)

(73) Assignee: BOUYGUES TELECOM, Paris (FR)

(21) Appl. No.: 14/434,751

(22) PCT Filed: Oct. 10, 2013
(86) PCT No.: PCT/EP2013/071222

§ 371 Date: Jun. 30, 2015

(30) Foreign Application Priority Data
Oct. 10, 2012 (FR) 1259675

(51) Int. Cl. H04W 48/16; H04W 76/02; H04W 48/18

(52) U.S. Cl. CPC H04W 48/16; H04W 48/18; H04W 76/02

(57) ABSTRACT

The present invention relates to a method of roaming for a terminal (10) connected to a first mobile telephone network (1a), the method being characterized in that it comprises the implementation by processing means of a subscriber identification card (11) of the terminal (10) of steps of: (a) detection of a deficiency affecting the data service of the first network (1a) to which the terminal (10) is connected; (b) inscribing of said first network (1a) for which a deficiency of the data service has been detected in a list of prohibited networks (FPLMN) that is stored in storage means of the subscriber identification card (11); (c) selection of a new network (1b, 1c) and connection of the terminal (10) to said new network (1b, 1c); (d) removal of said first network (1a) from said list of prohibited networks (FPLMN). The present invention relates moreover to a subscriber identification card and to a terminal.

### GENERAL TECHNICAL FIELD

The present invention relates to the field of network roaming in mobile telephony.

More precisely, it relates to a method of roaming for a terminal in the event of deficiency of the data service of a mobile telephone network.

### PRIOR ART

“Smart objects” are a type of computer device comprising a SIM card and capable of interacting autonomously with other objects or servers via mobile telephone networks. This field, now rapidly expanding, is dependent on network quality.

Smart objects (and mobile telephone user equipment in general) situated in a country that is not the country of origin of the service provider are said to be in a “roaming” situation, a situation wherein the risks of blocking caused by a network accident can be minimized.

Indeed, as they are defined by the GSM/UMTS standards in mobile networks, roaming mechanisms describe the capability of clients to access their mobile telephone services (voice or data) by selecting one of the local networks available in the area and if necessary by changing from one network to another.

Smart objects (and mobile telephone user equipment in general) thus have access to a high level of service, which is made possible, thanks to many roaming agreements signed between operators, by a switch from one operator to another during a network incident or as a function of the geographical coverage of each of the partner operators.

However, the selection of a network is nowadays based on the “GSM attach”. This means that if an incident on the network of an operator only affects the data and not the GSM location of this operator (therefore the voice), or if the coverage of the operator in the current area is limited to voice, the equipment still remains attached on this operator, even though an operator present in the same area could potentially supply the missing data service. The roaming then no longer fulfils its role.

A human user can circumvent the problem by choosing manual selection of the network, which however remains restrictive. In the case of smart objects, the only solution for using the manual mode would be to develop an intelligent functionality at application layer level (in the system of the smart object). However, this appears complex and would have to be specifically effected by each equipment manufacturer.

It would consequently be desirable to possess an improved roaming method which contributed a simple and universal back-up solution in the event of an incident involving the data service of a network, knowing that, as previously explained, roaming is described in standards and it is therefore not possible for the operators to substantially modify the existing mechanisms.

### PRESENTATION OF THE INVENTION

The present invention thus concerns a method of roaming for a terminal connected to a first mobile telephone network, the method being characterized in that it comprises performing, by the processing means of a subscriber identification card of the terminal, steps of:
(a) Detection of a deficiency affecting the data service of the first network to which the terminal is connected;
(b) Entering of said first network, for which a deficiency of the data service has been detected, in a list of forbidden networks (FPLMN) stored in storage means of the subscriber identification card;
(c) Selection of a new network and connection of the terminal to said new network;
(d) Removal of said first network from said list of forbidden networks (FPLMN).

According to other advantageous and non-limiting features of the method according to the invention:

the data service of the new network is tested following step (c), steps (b) and (c) being repeated if a deficiency of the data service of this new network is thus detected, each of the networks for which a deficiency of the data service has been successively detected being removed in step (d);

the method further includes, following step (a), the removal of said first network (1a) from a list of preferred networks (PPLMN) stored in the storage means of the subscriber identification card, and following step (d), the re-entry of said first network in the list of preferred networks (PPLMN);

the terminal is connected to a mobile telephone network via a modem, step (c) comprising prior to the connection of the terminal to the new network, either the refreshing of said modem and/or of said subscriber identification card, or the reloading by said modem of the files contained in the subscriber identification card.

step (a) comprises the detection of a loss of GPRS attach;

a loss of GPRS attach is detected via the consultation of a GPRS location information file (LOCIGPRS) stored in the storage means of the subscriber identification card;

said GPRS location information file (LOCIGPRS) is consulted following the notification to the data processing means of the subscriber identification card of an update of said GPRS location information file (LOCIGPRS);

step (a) comprises the detection of a failure to open a PDP session

step (a) comprises the detection, by processing means of the terminal, of a loss of connection to a remote server, and the sending to the subscriber identification card of a command characteristic of a deficiency affecting the data service of the first network to which the terminal is connected;

step (a) comprises the detection, by processing means of the terminal, of an abnormally low data rate, and the sending to the subscriber identification card of a command characteristic of a deficiency affecting the data service of the first network to which the terminal is connected;

step (a) comprises the triggering of a first timer and/or a counter at the end of which steps (b) to (d) are implemented;

step (d) comprises the triggering of a second timer and/or a counter before the end of which the method cannot be implemented again.

According to a second aspect, the invention relates to a subscriber identification card comprising data processing means and data storage means on which a list of forbidden networks (FPLMN) are stored, characterized in that the processing means of the subscriber identification card are configured for the implementation of the first aspect of the invention.

According to a third aspect, the invention relates to a terminal comprising data processing means, means for connecting to a mobile telephone network, characterized in that it further comprises a subscriber identification card according to the second aspect of the invention.

### PRESENTATION OF THE FIGURES

Other features and advantages of the present invention will become apparent on reading the following description of a preferred embodiment. This description will be given with reference to the single keyed FIGURE representing a diagram of a network architecture for the implementation of the method according to the invention.

### DETAILED DESCRIPTION

### Voice/Data

Current cellular phone technology is based on the distinction between exchanges of “voice” type and exchanges of “data” type. “Data” basically includes everything that is not “voice”. These two modes of exchange are discerned by their uses (basically telephone or SMS communications for voice, and Internet connections or connections between private networks for data) and by their switching mode. Specifically, “data” are exchanged in “packet” mode, according to the PDP (Packet Data Protocol). A data packet is thus composed of three elements:
The header, which contains the information required to transfer the packet from the transmitter to the receiver;
The payload, which contains the data;
The trailer, which comprises the error correcting code.

The division into voice and data is manifest in the respective use of GSM (Global System for Mobile communication) and GPRS (Global Packet Radio Service) standards. And as previously explained, the selection of the network is currently done solely on the basis of the “GSM attach”, in other words the availability of the voice service.

As explained previously, the present method aims to ensure a switch of network in the event of the data service being absent or disrupted, but the voice service being in normal operation (i.e. satisfactory GSM attach).

The term “disrupted data service” is understood to mean either a completely interrupted service (impossible or interrupted connection), or a much slower service (abnormally low data rate), and in general all cases in which the data rate is inadequate for satisfactory use. The term “absent data service” is understood to refer to a service not handled by the operator (a 2G GSM network not supporting GPRS, or an undeployed network). In the remainder of the present description, the term “deficiency” will be used to denote a disruption or absence of data service.

The various manifestations of a network service disruption will be described in detail further on.

It will be understood that the present method is not designed to handle cases of total disruption (voice+data) or of voice service disruption alone, for which current roaming mechanisms provide satisfaction. It is intended to operate in addition to the latter.

### SIM Card

A SIM (Subscriber Identity Module) card is a chip of UICC (Universal Integrated Circuit Card) type comprising data processing means (in the form of a microcontroller) and memory (of EEPROM (Electrically-Erasable Programmable Read-Only Memory) or flash type, generally of a size of 64 ko, although models of 128 or 256 ko are available).

It makes it possible to store information specific to the subscriber to the mobile telephone service, and optionally data and applications of the user (for example his or her telephone book).

Among the basic data (the organization of which is regulated by the GSM and GPRS standards) are so-called elementary files (EF), among which are lists of PLMN (Public Land Mobile Network), in other words the telecommunication networks between which roaming can take place.

Among these lists are the EF-FPLMN (the list of “Forbidden” PPLMNs) and the EF-PPLMN (the list of “Preferred” PPLMNs), each being able to contain the name of four networks. The first consists of the networks the SIM is forbidden to connect to, and the second consists of the networks to which the SIM connects as a priority. Other files exist, for example the EF-LOCI and EF-LOCIGPRS (LOCation Information) which will be described further on.

Note that the present invention particularly pertains to the case of international roaming, as explained previously, but it is understood that it could be equally applicable in the case of national roaming (roaming in the country of origin of the SIM card).

### Principle of the Invention

The present method is based on the temporary use of the list of FPLMNs to discard a network with deficient (disrupted or absent) data service.

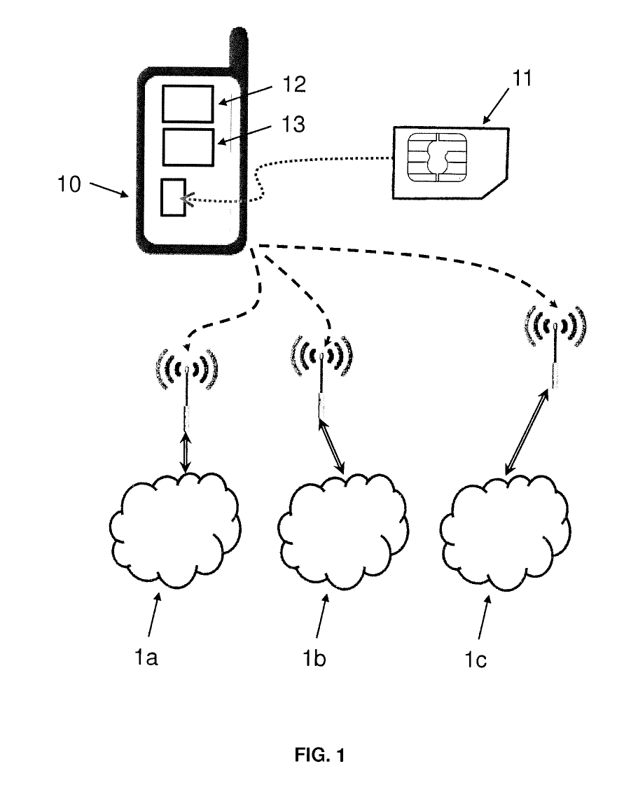

With reference to FIG. 1, the method according to the invention is implemented (at least for the most part, as will be seen later on) by a subscriber identification card 11 (the term “subscriber identification card” is understood to include any integrated circuit capable of providing subscriber identification functions via data that are stored therein, and especially a SIM card), of a terminal 10 connected to a first mobile telephone network 1a, a network for which an incident of the data service is in progress.

At least one other network is available. FIG. 1 represents a second network 1b and a third network 1c. The terminal 10 can connect to each of the networks 1a, 1b, 1c via connection means of the terminal 10 and the antenna relays of the networks 1a, 1b, 1c. It is quite possible (although statistically improbable) that two networks simultaneously exhibit a deficiency in their data service, and as will be seen further on this case can be taken into account and resolved by the present roaming method.

It will however be assumed in the remainder of the present description that there exists at any time at least one network for which the data service is operational (in other words non-deficient). If in the worst case all the networks were deficient, the method makes provision for a way out as will be seen further on.

The terminal 10 can as explained previously be either a smart object, or a personal mobile telephone (a smartphone, a touch-sensitive tablet etc.). In all cases, it comprises data processing means 13 for the implementation of a system and applications, and a modem 12 for connection to the data service. As explained, it comprises a subscriber identification card 11 (in particular a SIM card as previously described) for the storage of information about the connection to the mobile telephone networks and particularly of the EF files.

In the remainder of the present description, the example of a SIM card will be chosen, but it is understood that the term “subscriber identification” must not be reduced to SIM cards but can relate to any current or future media for identifying the subscriber, whatever their technology, i.e. not necessarily chips of UICC type. It should moreover be noted that it is currently commonplace for smart objects not to exhibit the “conventional” format of a SIM card but to be directly welded onto the motherboard. Furthermore, by way of example, alternative solutions may be cited using microSD (Secure Digital) cards, which also comprise data processing means and a storage space capable of storing EF files.

The roaming method comprises a first step of detection of a deficiency affecting the data service of the first network 1a to which the terminal 10 is connected. Various ways of detecting this loss of service will be described further on.

In a second step, the method comprises the entering of said first network 1a, for which a deficiency of the data service has been detected, into a list of forbidden networks (FPLMN) stored in storage means of the SIM card 11.

In a third step, the method comprises the selection of a new network 1b, 1c and the connection of the terminal 10 to said new network 1b, 1c. This step is particularly done by refreshing the modem 12 of the terminal 10 (the term refresh is understood to mean a simple update of the connection and not necessarily a restart of the modem) and/or the SIM card 11. Note that refreshes of the SIM card 11 and the modem 12 are generally linked, to the extent that the restart of one currently entails the restart of the other. A restart of the terminal 10 moreover entails in all cases the restart of these two components.

Alternatively, in this third step provision can be made for asking the modem 12, in particular via a standard command (refresh option of “SIM initialization” type), to reload the files contained in the SIM card 11 and therefore to trigger a new network selection.

Whereas the modem 12 would theoretically have had to simply reconnect to the problematic network 1a (because it is the last operational network in terms of voice service to which the terminal was connected, and it is hence entered in a list EF-LOCI of the storage means of the SIM card 11), the fact that this network is classed as forbidden prevents it from doing so.

The modem then chooses one of the other networks 1b, 1c available (generally choosing that with the highest received power or a “preferred” network as will be seen further on, because it has high chances of being the network with the best communication quality) and connects to it.

Note that the new network is retested. Indeed, the fact that the modem 12 has decided to connect to this network means only that its voice service is operational, and it is perfectly possible that its data service is also deficient (the probability that two networks of two operators are simultaneously faulty is minute, but the case can be envisioned wherein the new network captured is purely a voice network, or that it is already severely congested because of the failure of the former). Where applicable, the second and third steps of the method are repeated, and the new network is added to the list of FPLMNs (in order that neither it nor the previous network can be selected following the 2^{nd} refresh of the modem 12).

The second and third steps can be repeated iteratively until a network is found for which the data service is not deficient. Note that the list of FPLMNs of a SIM card 11 is generally intended to contain up to four networks, but it can be realistically assumed that this limit does not pose any problem (that would require a simultaneous failure of five networks!)

According to an advantageous embodiment, a counter is provided which counts the number of iterations of the method. Using this counter, a threshold value can be provided (in particular three or four), beyond which the method is not further refreshed even if the data service is still deficient. This makes it possible to prevent a situation of global failure (for example at the level of an internet node, which would affect a whole territory) wherein no network 1a, 1b, 1c would be in a position to supply data services, or even to block any aberrant behavior. The probability that four or five networks will simultaneously undergo independent failures is indeed very low. At the end of the counter (i.e. when an attempt is made to refresh the method when the set threshold, here three or four, has already been attained), in the absence of the method being refreshed, the modem 12 remains connected to a network 1a, 1b, 1c only possessing the voice service. In this situation of the threshold being reached, the list of forbidden networks (FPLMN) is “purged”, i.e. as will be seen further on the list is reset to zero to stop any effect of the method. One option may consist in adding a refresh request as in the third step.

The fourth step of the method consists in a resetting of the list of forbidden networks list (FPLMN) to the state it was in before the start of the method (in other words the removal of the entered network or networks), once it has been possible to establish a connection to a valid network (voice as well as data). Indeed, the first network(s) 1a added to this list exhibits or exhibit a deficiency that has every chance of being only a temporary incident, and the terminal 10 should not be deprived of the possibility of a future connection to this network. In the case where the list of forbidden networks FPLMNs was initially empty, this step consists in a “purge” of the list, i.e. a reset to zero. It is also possible to envision purging the list in all cases to avoid any negative side-effects of the SIM card 11 during its lifetime (independently of the method).

Note that in the case of a counter as described previously, the latter is also reset to zero in this fourth step.

At the next restart of the terminal 10, or the next deficiency of the “current” network, or a new triggering of the method, the terminal 10 will consider the old network 1a as any other mobile telephone network.

By way of example (assuming an empty list of PPLMNs, see further on), it can be assumed with reference to FIG. 1 that the first network 1a is undergoing a failure of the data service, that the second network 1b is purely a voice network, and that the third network 1c exhibits an operational data service, but is a network with less power than the second network 1b.

This means that following the first implementation of the three first steps of the method, the first network 1a is in the list of FPLMNs and the second network 1b is the new network chosen as replacement. This new network is then tested (in a step similar to the first step of the method). It is then observed that this new network (the second network 1b) does not offer any data service, and the method is repeated. The second network 1b is placed in turn in the list of FPLMNs, and thus only the third network 1c can be selected by the modem 12.

This third network 1c being operational for voice as well as data, the method is not repeated and the list of FPLMNs is purged (it contained the first and second networks 1a, 1b). The counter, which had the value of (2), is reset to zero.

Note that the EF space of the memory of the SIM card can contain a list of preferred networks (PPLMN). However, in the scenario of a network being entered both in the list of PPLMNs and the list of FPLMNs, some modems 12 could react badly. Out of a concern for security, if a network from the list of PPLMNs were to undergo a network incident, it can be possible to rule that this list of PPLMNs must be empty, or remove the first network detected as exhibiting a detected deficient data service (which is done for the list of FPLMNs in the last step of the method) as soon as the method is triggered (following the first step), and to reenter it in the list of PPLMNs at the time of purging of the FPLMNs.

According to an advantageous embodiment of the invention, it is possible to use timers, in addition to or as a replacement for the counter already cited, to limit accidental and repeated switches. For this the Poll Interval function of the standardized STK (Sim Tool Kit) function is used.

Firstly, it is possible to make the triggering of the method (i.e. the detection of a deficiency of the data service of the first step) conditional on a first timer. In other words following a first detection, the data service is retested at the end of this first timer to verify that the observed deficiency was not an artifact or the temporary result of poor positioning of the terminal with respect to an antenna. It should be noted that the standard provides for several attempts to connect to the modem in case of failure, and the timer also makes it possible to wait until all these attempts have been made.

Alternatively or additionally, it is possible to provide for the triggering of a second timer (at the time of the fourth step, i.e. when the choice of a new network is approved) before the end of which the method cannot be implemented again. This makes it possible to “freeze” the switch for a given time period.

### Detection of a Deficiency Affecting the Data Service of the First Network

It will be understood that the present method is not limited to any particular way of detecting a deficiency in the data service.

A first possibility, given by way of example, consists in detecting a loss of “GPRS attach”, by analogy with the GSM attach (which is characteristic of the nominal operation of the voice service). To do this, the data processing means of the SIM card 11 can consult a file of GPRS location information (LOCIGPRS) also stored in the EF space of the storage means of the SIM card 11. This file also particularly contains the information made available by the terminal 10 about the state of the GPRS attach and can indeed contain the identifier of an access point of the data service.

Knowing that the data processing means of the SIM card 11 are notified of an update of the LOCIGPRS file by the modem 12, a verification of the GPRS attach is preferably implemented upon each of these notifications. Alternatively, this technique can be employed at regular intervals to poll the state of the data service. To do this the Poll Interval function of the standardized function STK (Sim Tool Kit) is used.

A second possibility, also given by way of example, consists in detecting a failure to open a PDP session, PDP (Packet Data Protocol) being as explained the protocol of the data service. This detection has the advantage of being employed when the data service is used. To do this, the data processing means of the SIM card 11 can question the modem 12 via an AT command. “AT+CGATT?” encapsulated in an APDU (Application Protocol Data Unit) message and obtain a reply as to whether or not the PDP session is activated.

This technique can similarly be employed at regular intervals to poll the state of the data service. This will for example be the case, after a predefined timeout, after having detected that the GPRS attach is operational (check described in the first possibility described above).

These two techniques for detecting a deficiency of the data service can be entirely implemented by the SIM card 11 itself, and therefore allow an implementation of the whole method by the SIM card 11 alone. It is then not necessary to effect the slightest modification of an application layer of the terminal 10. The only prerequisites of the modem 12 are support for the STK function (especially the Refresh command) and for the AT command above.

Alternatively or additionally, one or more detection techniques can be employed at application level (and therefore by the processing means 13 of the terminal 10.) The first step of the method then comprises the sending to the SIM card 11 of a command characteristic of a deficiency affecting the data service of the first network 1a to which the terminal 10 is connected. This command can more specifically be an STK (SIM Tool Kit) command or a proprietary command encapsulated in an APDU (Application Protocol Data Unit) message. This is a GSM standard defining a set of commands making it possible to initiate actions at the level of the SIM card 11. STKIAPDU commands are therefore particularly suitable for the triggering of the present method. On receiving this command, the processing means of the SIM card 11 will trigger the method for allowing the change of network (second, third and fourth steps).

The use of the application layer involves software modifications of the systems of the terminals, but allows much more accurate deficiency detection. Indeed, it is quite possible that the data service is disrupted even though no loss of GPRS attach or PDP session has been observed.

A third possibility, also given by way of example, consists in the detection, by the processing means 13 of the terminal 10, of a loss of connection to a remote server. This is done by detection of an absence of dialogue between the terminal and a remote task-specific app following requests, or of a PING without reply. This is particularly useful in the case of a smart object, which is intended to be constantly in connection with a given application server. A loss of exchange with this server is synonymous with failure, whatever the state of the network parameters. It is however important that a failure of the remote server not be incorrectly interpreted as a failure of the data service, which is why several remote servers must preferably be tested.

A fourth possibility, also given by way of example, consists in the detection, by processing means 13 of the terminal 10, of an abnormally low data rate. Indeed, it can still be possible that the link with the application server is unbroken, but that the data service incident in progress leads to a particularly low data rate, leading to slow-downs or even packet loss. Such a degradation of the data service can be enough to justify the triggering of the roaming method. Data rate measurement techniques are well known to those skilled in the art.

It is understood that the method can make use of each of these techniques in isolation or in addition to one another.

### Subscriber Identification Card & Terminal

According to a second and a third aspect, the invention relates firstly to a subscriber identification card 11 comprising data processing means and data storage means on which a list of forbidden networks (FPLMN) are stored, the processing means of the subscriber identification card being configured for the implementation of the method according to the first aspect; and secondly to the terminal 10 comprising data processing means 13, means for connecting to a mobile telephone network 1a, and a subscriber identification card 11 according to the second aspect.

The subscriber identification card 11 according to the second aspect of the invention is preferably a SIM card configured for implementing a detection of a deficiency affecting the data service of the first network according to the first (GPRS attach) or the second (PDP session) technique described previously, in such a way as to be “self-sufficient”: the simple insertion of this SIM card 11 into a terminal 10 makes it possible to implement the method, without any modification of the terminal.

On the other hand, the terminal 10 according to the third aspect of the invention is preferably configured to implement a detection of a deficiency affecting the data service of the first network according to the third technique (connection to a remote application server) or the fourth technique (data rate measurement) described previously, the subscriber identification card 11 then receiving a command transmitted by the data processing means 13 of the terminal 10 signaling a deficiency affecting the data service.

1. A method of roaming for a terminal (10) connected to a first mobile telephone network (1a), the method being characterized in that it comprises the implementation, by the processing means of a subscriber identification card (11) of the terminal (10), of steps of:
(a) Detection of a deficiency affecting the data service of the first network (1a) to which the terminal (10) is connected;
(b) Entering of said first network (1a), for which a deficiency of the data service has been detected, in a list of forbidden networks (FPLMN) stored in storage means of the subscriber identification card (11);
(c) Selection of a new network (1b, 1c) and connection of the terminal (10) to said new network (1b, 1c;
(d) Removal of said first network (1a) from said list of forbidden networks (FPLMN).

2. The method according to claim 1, wherein the data service of the new network (1b, 1c) is tested following step (c), steps (b) and (c) being repeated if a deficiency of the data service of this new network is thus detected, each of the networks for which a deficiency of the data service has been successively detected being removed in step (d).

3. The method according to one of the preceding claims, further comprising, following step (a), the removal of said first network (1a) from a list of preferred networks (PPLMN) stored in the storage means of the subscriber identification card (11), and following step (d), the re-entering of said first network (1a) in the list of preferred networks (PPLMN).

4. The method according to one of the preceding claims, wherein the terminal (10) is connected to a mobile telephone network (1a, 1b, 1c) via a modem (12), step (c) comprising prior to the connection of the terminal (10) to the new network (1b, 1c) either the refreshing of said modem (12) and/or of said subscriber identification card (11), or the reloading by said modem (12) of the files contained in the subscriber identification card (11).

5. The method according to one of the preceding claims, wherein step (a) comprises the detection of a loss of GPRS attach.

6. The method according to claim 5, wherein a loss of GPRS attach is detected via the consultation of a GPRS location information file (LOCIGPRS) stored in the storage means of the subscriber identification card (11).

7. The method according to claim 6, wherein said GPRS location information file (LOCIGPRS) is consulted following the notification to the data processing means of the subscriber identification card (11) of an update of said GPRS location information file (LOCIGPRS).

8. The method according to one of the preceding claims, wherein step (a) comprises the detection of a failure to open a PDP session.

9. The method according to one of the preceding claims, wherein step (a) comprises the detection, by processing means (13) of the terminal (10), of a loss of connection to a remote server, and the sending to the subscriber identification card (11) of a command characteristic of a deficiency affecting the data service of the first network (1a) to which the terminal (10) is connected.

10. The method according to one of the preceding claims, wherein step (a) comprises the detection, by processing means (13) of the terminal (10), of an abnormally low data rate, and the sending to the subscriber identification card (11) of a command characteristic of a deficiency affecting the data service of the first network (1a) to which the terminal (10) is connected.

11. The method according to one of the preceding claims, wherein step (a) comprises the triggering of a first timer and/or a counter at the end of which steps (b) to (d) are implemented.

12. The method according to one of the preceding claims, wherein step (d) comprises the triggering of a second timer and/or a counter before the end of which the method cannot be implemented again.

13. A subscriber identification card (11) comprising data processing means and data storage means on which a list of forbidden networks (FPLMN) are stored, characterized in that the processing means of the subscriber identification card (11) are configured for the implementation of the method according to one of claims 1 to 12.

14. A terminal (10) comprising data processing means (13), means for connecting to a mobile telephone network (1a), characterized in that it further comprises a subscriber identification card (11) according to claim 13.
